(19) United States
(12) Patent Application Publication
(10) Pub. No.: US 2025/0083939 A1
(43) Pub. Date: Mar. 13, 2025

(54) AERIAL LIFT FOR WORKING AT HEIGHT, CONTROL METHOD AND ASSEMBLY COMPRISING SUCH AN AERIAL LIFT

(71) Applicant: MANITOU BF, ANCENIS (FR)

(72) Inventors: François QUONIAM, ANCENIS (FR); Valentin BREHIER, ANCENIS (FR)

(21) Appl. No.: 18/689,347

(22) PCT Filed: Sep. 1, 2022
(86) PCT No.: PCT/FR2022/051651

§ 371 Date: Dec. 2, 2024

(30) Foreign Application Priority Data
Sep. 6, 2021 (FR) FR2109309

(51) Int. Cl. B66F 17/00; B66F 11/04

(52) U.S. Cl. CPC B66F 17/006; B66F 11/04

(57) ABSTRACT

The disclosure relates to an aerial lift including a platform having a control console equipped with controls for a device for driving the height-wise movement of the platform, an anchor point that can be occupied by an anchoring device for anchoring safety equipment, a detection system detecting whether the anchor point is occupied or unoccupied, and a device for emitting a warning signal. A control unit is configured to control the device for emitting a warning signal according to whether the anchor point is occupied or unoccupied and according to the position of the lifting structure, the control unit being configured so that when the anchor point is unoccupied the control unit commands the emitting of a luminous or acoustic warning signal the intensity and/or frequency and/or tonality of which varies according to the position of the lifting structure.

The present invention relates to an aerial lift for working at height, to its control method and to an assembly comprising such an aerial lift.

It relates in particular to an aerial lift comprising:
a chassis,
a platform having a location for receiving an operator,
a device for driving the movement of the platform with respect to the chassis, said device for driving the movement of the platform comprising at least one lift structure for the platform mounted so as to be movable at least in the direction of a raising and a lowering of said platform, and
a control unit,
said platform comprising a control console equipped with one or more controls for the device for driving the movement of the platform, at least one anchoring location liable to be occupied by an anchoring of a device for anchoring an item of safety equipment, a system for detecting the occupied or unoccupied state of the anchoring location and a device for emitting a luminous or audible warning signal, said control unit being configured at least to acquire data from the detection system as a function of the occupied or unoccupied state of the anchoring location.

Such an aerial lift with an operator wearing a safety harness equipped with a tether terminated by a carabiner able to be attached to the platform of the aerial lift to protect the operator from falling from the platform is known, as illustrated in U.S. Pat. No. 9,245,434. Likewise, documents US 2019/152753 and U.S. Pat. No. 6,330,931 illustrate a safety system making it possible to emit a warning signal when the operator is not correctly attached to the platform. However, it is frequently found that the operator does not fasten the carabiner to the platform. A radical solution may consist in preventing any operation of the aerial lift while the carabiner is not attached to the platform. However, this solution poses a number of problems and may potentially be dangerous.

An aim of the invention is to propose an aerial lift and an assembly comprising such an aerial lift which are designed to warn the operator in an optimized manner.

To that end, a subject of the invention is an aerial lift comprising:
a chassis,
a platform having a zone for receiving an operator,
a device for driving the movement of the platform with respect to the chassis, said device for driving the movement of the platform comprising at least one lift structure for the platform mounted so as to be movable at least in the direction of a raising and a lowering of said platform, and
a control unit,
said platform comprising a control console equipped with one or more controls for the device for driving the movement of the platform, at least one anchoring location liable to be occupied by a device for anchoring an item of safety equipment, a system for detecting the occupied or unoccupied state of the anchoring location and a device for emitting a luminous or audible warning signal, said control unit being configured at least to acquire data from the detection system as a function of the occupied or unoccupied state of the anchoring location,
   characterized in that the aerial lift comprises a system for determining the position of the lift structure for the platform, and in that the control unit is configured to control the device for emitting a warning signal at least as a function of the occupied or unoccupied state of the anchoring location and the position of the lift structure, said control unit being configured to, in the unoccupied state of the anchoring location, control the emission of a warning signal, of which the intensity and/or the frequency and/or the tonality, i.e. the color for a luminous warning signal or the melody for an audible warning signal, varies at least as a function of the position of the lift structure.

By virtue of the fact that the control unit is configured to, in the unoccupied state of the anchoring location, control the emission of a warning signal, of which the intensity and/or the frequency and/or the tonality, i.e. the color for a luminous warning signal or the melody for an audible warning signal, varies at least as a function of the position of the lift structure, the operator who has not attached their safety equipment to the platform can be warned as a function of the level of risk of falling from the platform. This design allows the operator to be warned in proportion to the risk involved. In particular, this design allows the operator to more particularly be warned when they are controlling the aerial lift for passage of the aerial lift from what is referred to as a transport configuration, which corresponds to a low position or to a range of determined low positions of the lift structure, to what is referred to as a working configuration, in which the platform of the aerial lift can be raised to a significant height.

According to one embodiment of the invention, the lift structure comprises a lifting arm mounted so as to be pivotable with respect to the chassis between a low position and a high position, and the system for determining the position of the lift structure for the platform is a system for determining the position of the lifting arm of said lift structure.

The control unit may therefore be configured to, in the unoccupied state of the anchoring location, control the emission of a warning signal, of which the intensity and/or the frequency and/or the tonality, i.e. the color for a luminous warning signal or the melody for an audible warning signal, varies at least as a function of the position of the lifting arm of the lift structure. The control unit may thus be configured to, in the unoccupied state of the anchoring location, control the emission of what is referred to as a “strong” warning signal, i.e. of which the intensity and/or the frequency and/or the tonality is modified so as to be able to be understood as an increase in the risk for the operator, when the lifting arm leaves the low position. This movement of the lifting arm away from the low position corresponds, for a large number of aerial lifts, to the passage of the aerial lift from the transport configuration, in which a movement of the chassis of the aerial lift along the ground is possible, to the working configuration, in which such a movement of the chassis of the aerial lift along the ground at high speed is no longer possible.

According to one embodiment of the invention, the device for driving the movement of the platform with respect to the chassis comprises at least one actuator, such as a cylinder, for driving the movement of the lifting arm, and the system for determining the position of the lifting arm for the platform comprises at least a position sensor for the lifting arm and/or a position sensor for said actuator.

According to one embodiment of the invention, the lifting arm for the platform, disposed between the chassis and the platform, is coupled to the platform by a pendulum arm, and the controls for the device for driving the movement of the platform which equip the control console comprise at least a movement control for the pendulum arm and a movement control for the lifting arm. It is thus possible, when the detection of the position of the lift structure is effected at the level of the lifting arm, to emit a “weak” warning signal when only the pendulum arm is driven in movement whilst the lifting arm is still in a low position.

According to one embodiment of the invention, the chassis is equipped with a system for driving the movement of said chassis along the ground, and the control console is equipped with at least one member for controlling the system for driving the movement of said chassis along the ground. The control unit is configured to allow/prevent the control of the system for driving the movement of the chassis along the ground from the control console as a function of the data supplied by the system for determining the position of the lift structure for the platform.

According to one embodiment of the invention, the platform comprises at least one member for activating/deactivating at least a portion of the control or controls for the device for driving the movement of the platform which equip the control console, said activating/deactivating member being mounted so as to be movable between an inactive position, in which at least a portion of the control or controls for the device for driving the movement of the platform is inactive, and an active position, in which at least a portion of the control or controls for the device for driving the movement of the platform is activated, and the control unit is configured to, in the unoccupied state of the anchoring location, control the emission of a warning signal, of which the intensity and/or the frequency and/or the tonality, i.e. the color for a luminous warning signal or the melody for an audible warning signal, varies at least as a function of the position of said activating/deactivating member.

Preferably, the activating/deactivating member is a pedal or a lever, such as a trigger, equipped with at least one member for returning into the active position and is configured to pass from the inactive position to the active position under the action of a push exerted on said activating/deactivating member counter to said at least one return member. This activating/deactivating member is frequently called dead man's pedal or lever or trigger. Once again, the activation of such a member indicates that the operator wishes to drive the movement of the chassis or the platform and allows the control unit to control the emission of a warning signal taking account of this increase in the risk of falling from the platform.

According to one embodiment of the invention, the platform comprises a floor and a guardrail surrounding at least a portion of the floor, and the or at least one of the anchoring locations has the form of a frame delimiting an opening, said frame being provided at the guardrail. In the case of a device for anchoring safety equipment to the platform formed by a carabiner, it suffices for the carabiner to surround an edge of the frame in order to be fastened to the frame. This results in simplicity of implementation.

According to one embodiment of the invention, the system for detecting the occupied or unoccupied state of the anchoring location comprises, disposed along a face of the frame formed by the anchoring location, a mechanical member mounted so as to be movable between a position close to the anchoring location, corresponding to the unoccupied position of the anchoring location, and a position spaced apart from the anchoring location, corresponding to the occupied position of the anchoring location, an element for returning said mechanical member into the position close to the anchoring location and a sensor for determining the position of said mechanical member, and the control unit is configured to acquire the data supplied by said sensor for determining the position of said mechanical member.

According to one embodiment of the invention, the device for emitting a luminous or audible warning signal comprises at least one lighting member, such as a light-emitting diode, disposed around the or at least one of the anchoring locations within a radius of less than 15 cm. It is at least at this lighting member that the luminous warning signal is emitted. This arrangement directs the operator's eye in the direction of the anchoring location in order to remind them that they have not attached their safety equipment to the platform.

According to one embodiment of the invention, the device for emitting a luminous or audible warning signal comprises a luminous indicator disposed on the control console. It is at least at this luminous indicator that the luminous warning signal can be emitted. This redundancy of the warning signal avoids any absence of visualization of the luminous warning signal by the operator.

A further subject of the invention is an assembly comprising an aerial lift and an item of safety equipment, such as a harness, equipped with an anchoring device, such as a carabiner, said aerial lift comprising:
a chassis,
a platform having a zone for receiving an operator,
a device for driving the movement of the platform with respect to the chassis, said device for driving the movement of the platform comprising at least one lift structure for the platform mounted so as to be movable at least in the direction of a raising and a lowering of the platform, and
a control unit,
said platform comprising a control console equipped with one or more controls for the device for driving the movement of the platform, at least one anchoring location for anchoring the device for anchoring the item of safety equipment, a system for detecting the occupied or unoccupied state of the anchoring location by said anchoring device and a device for emitting a luminous or audible warning signal, said control unit being configured at least to acquire data from the detection system as a function of the occupied or unoccupied state of the anchoring location,
   characterized in that the aerial lift, which is in accordance with the one described above, comprises a system for determining the position of the lift structure for the platform, and in that the control unit is configured to control the device for emitting a warning signal at least as a function of the occupied or unoccupied state of the anchoring location and the position of the lift structure, said control unit being configured to, in the unoccupied state of the anchoring location, control the emission of a warning signal, of which the intensity and/or the frequency and/or the tonality, i.e. the color for a luminous warning signal or the melody for an audible warning signal, varies at least as a function of the position of the lift structure.

A further subject of the invention is a method for controlling an aerial lift comprising:
a chassis,
a platform having a zone for receiving an operator,
a device for driving the movement of the platform with respect to the chassis, said device for driving the movement of the platform comprising at least one lift structure for the platform mounted so as to be movable at least in the direction of a raising and a lowering of said platform, and
a control unit,
said platform comprising a control console equipped with one or more controls for the device for driving the movement of the platform, at least one anchoring location for anchoring a device for anchoring an item of safety equipment, a system for detecting the occupied or unoccupied state of the anchoring location by said anchoring device and a device for emitting a luminous or audible warning signal, and said control unit being configured at least to acquire data from the detection system as a function of the occupied or unoccupied state of the anchoring location,
   characterized in that, since the aerial lift comprises a system for determining the position of the lift structure for the platform, the method comprises, in the unoccupied state of the anchoring location, a step of emitting a warning signal, of which the intensity and/or the frequency and/or the tonality, i.e. the color for a luminous warning signal or the melody for an audible warning signal, varies at least as a function of the position of the lift structure.

### BRIEF DESCRIPTION OF THE DRAWINGS

The invention will be clearly understood on reading the following description of exemplary embodiments, with reference to the appended drawings, in which:

FIG. 1 shows a perspective view of an aerial lift according to the invention;

FIG. 2 shows a perspective view of an aerial lift according to the invention;

FIG. 3 shows a partial perspective view of an aerial lift according to the invention with a detail view of the location for anchoring the device for anchoring the item of safety equipment;

FIG. 4 shows a perspective view of an aerial lift according to the invention taken in the region of the control console;

FIG. 5 shows a partial perspective view of an aerial lift according to the invention taken in the region of the anchoring location;

FIG. 6 shows a partial perspective view of an aerial lift according to the invention taken in the region of the system for detecting the occupied or unoccupied state of the anchoring location, the anchoring location being in the unoccupied state;

FIG. 7 shows a partial perspective view of an aerial lift according to the invention taken in the region of the system for detecting the occupied or unoccupied state of the anchoring location, the anchoring location being in the occupied state.

As mentioned above, the subject of the invention is an aerial lift 1 allowing a person to work at height and an assembly comprising such an aerial lift 1 and an item of safety equipment 21 equipped with an anchoring device 22 which will be described below. This aerial lift 1 comprises a chassis 2. This chassis 2 is preferably a self-propelled, i.e. motorized, chassis 2 equipped with a drive system 15 for driving the movement of the chassis 2 along the ground.

In the example shown, the chassis 2 is a rolling chassis, at least some of the wheels of which are driving wheels. In the example shown, the chassis 2 is equipped with four wheels. Instead of wheels, the chassis 2 could be equipped with tracks or other members for driving the movement of the chassis 2 along the ground, without departing from the scope of the invention.

The system 15 for driving the movement of the chassis 2 along the ground therefore comprises one or more motors. Thus, as mentioned above, one or more wheels of the chassis 2 are driving wheels.

In the example shown, the driving wheels are wheels connected to an electric motor integrated into the chassis 2. Likewise, some wheels are steered wheels, having a variable orientation with respect to the chassis 2, so as to steer the aerial lift 1.

The electric motor or motors may be replaced by a combustion engine connected to the wheels by way of a, preferably hydrostatic, transmission which may comprise a hydrostatic pump and the hydraulic motors each associated with what is referred to as a driving wheel.

The detail of this transmission will not be described in detail because such a transmission is well known to those skilled in this art.

Likewise, the system 15 for driving the movement of the chassis 2 along the ground will not be described in detail because it is well known to those skilled in this art.

The aerial lift 1 also comprises a platform 3 having a zone 4 for receiving an operator.

This work platform 3 is in this case formed of a floor 18 and of a guardrail 19 surrounding the floor while still allowing access to the inside of said platform 3.

The operator 20 is generally standing inside the zone 4 for receiving the operator of the platform 3.

The aerial lift 1 also comprises a device 5 for driving the movement of the platform 3 with respect to the chassis 2 disposed at least partially between the chassis 2 and the platform 3.

This device 5 for driving the movement of the platform 3 can assume a large number of forms.

This device 5 for driving the movement of the platform 3 comprises at least one lift structure 6 for the platform 3 mounted so as to be movable at least in the direction of a raising and a lowering of said platform 3.

In the example shown, the lift structure 6 comprises a lifting arm 61 mounted so as to be pivotable with respect to the chassis 2 between a low position and a high position.

The pivot axis of the lifting arm 61 extends horizontally when the aerial lift 1 is in the state positioned on a horizontal support plane.

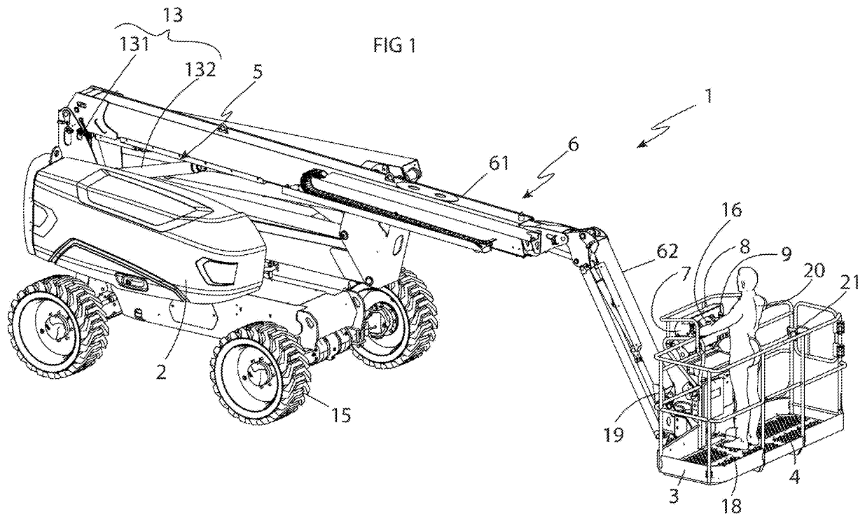

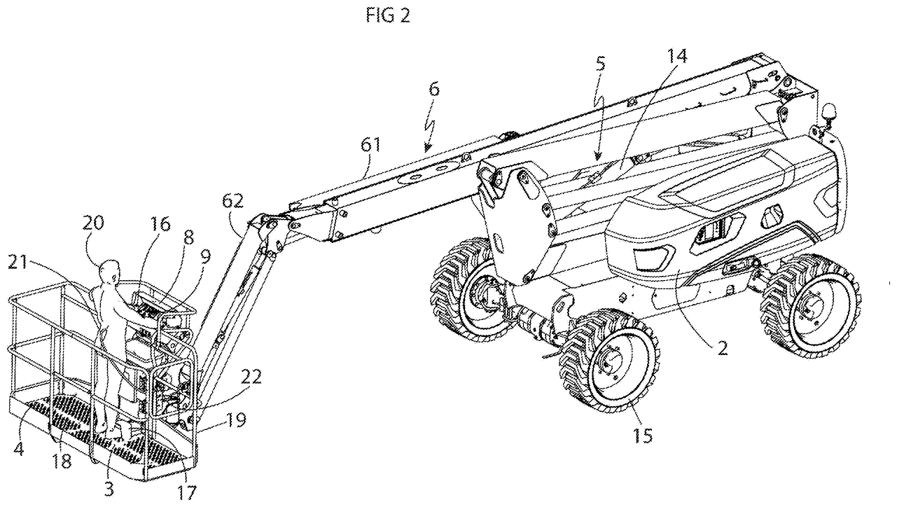

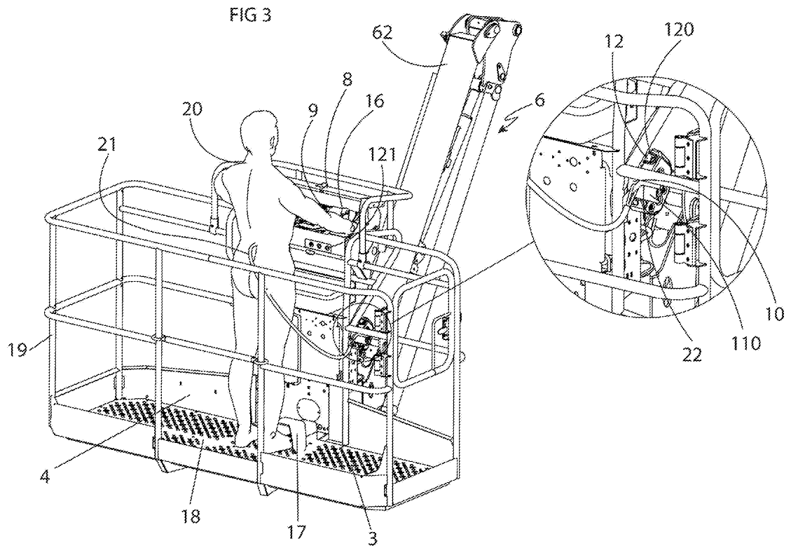

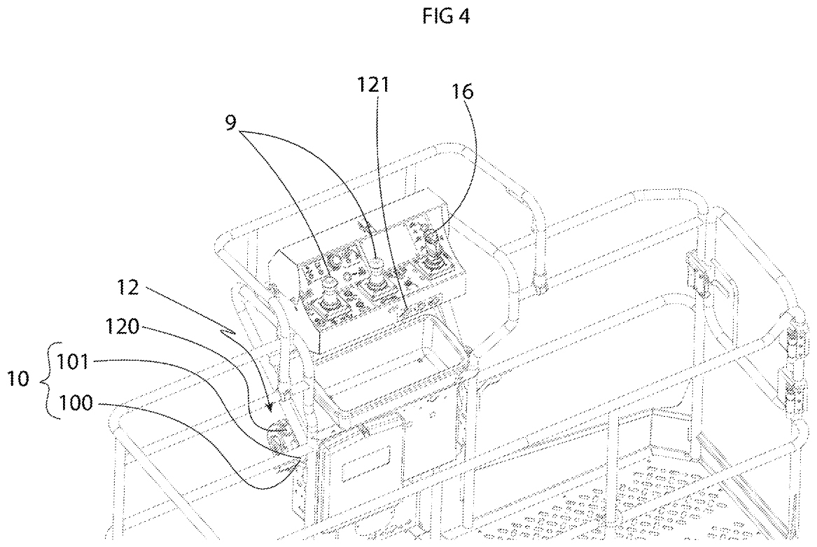

The platform 3 may be disposed directly at the end of this lifting arm 61. In a variant, and as shown in FIG. 1, the lifting arm 61 for the platform 3, disposed between the chassis 2 and the platform 3, is coupled to the platform 3 by a pendulum arm 62.

In the case of a lift structure 6 comprising a lifting arm 61, the device 5 for driving the movement of the platform 3 with respect to the chassis 2 comprises at least one actuator 14, such as a cylinder, for driving the movement of the lifting arm 61 between a high position and a low position.

In the examples shown, a first actuator 14 is disposed between the chassis 2 and the lifting arm 61. A second actuator is disposed between the lifting arm 61 and the pendulum arm 62. A third actuator may also be provided between the platform 3 and the pendulum arm 62 when it is present or between the lifting arm 61 and the platform 3.

In a variant, and in a manner that is not shown, the lift structure 6 may comprise one or more superposed scissors, two of the ends of the scissors, or of the topmost scissors in the case of a superposition of scissors, are connected to the platform.

Once again, one or more actuators enable a movement of such a lift structure 6 mounted so as to be movable between a folded low position of the scissors and a deployed high position of the scissors.

The detail of this device 5 for driving the movement of the platform 3 will not be described in more detail because it is well known to those skilled in this art.

The aerial lift 1 comprises a control unit 7. Said control unit 7 is in the form of an electronic computer system which comprises, for example, a microprocessor and a working memory. According to a particular aspect, the control unit may be in the form of a programmable automaton. In other words, the functions and steps described may be implemented in the form of a computer program or using hardware components (for example programmable gate arrays). In particular, the functions and steps performed by the control unit or the modules thereof may be performed by sets of instructions or computer modules implemented in a processor or controller or may be performed by dedicated electronic components or components of the programmable logic circuit (or FPGA standing for field-programmable gate array) type or of the application-specific integrated circuit (ASIC) type. It is also possible to combine computer portions and electronic portions. When it is specified that the unit or means or modules of said unit are configured to perform a given operation, that means that the unit comprises computer instructions and the corresponding means of execution to allow said operation to be performed and/or that the unit comprises corresponding electronic components.

The aerial lift 1 also comprises a control console 8 equipped with one or more controls 9 for the device 5 for driving the movement of the platform 3.

In the example shown, the controls 9 for the device 5 for driving the movement of the platform 3 which equip the control console 8 comprise a movement control for the pendulum arm 62 and a movement control for the lifting arm 61. Without preference, these controls 9 may take the form of a pivoting lever, also called joystick, of buttons, of switches or other forms.

In the example shown, the movement control for the pendulum arm 62 is a pivoting lever and the movement control for the lifting arm 61 is also formed by a pivoting lever.

The chassis 2 is equipped with a system 15 for driving the movement of said chassis along the ground, and the control console 8 is equipped with at least one member 16 for controlling the system 15 for driving the movement of said chassis along the ground.

This member 16 for controlling the system 15 for driving the movement of the chassis 2 along the ground is, in the example shown, formed by a pivoting lever.

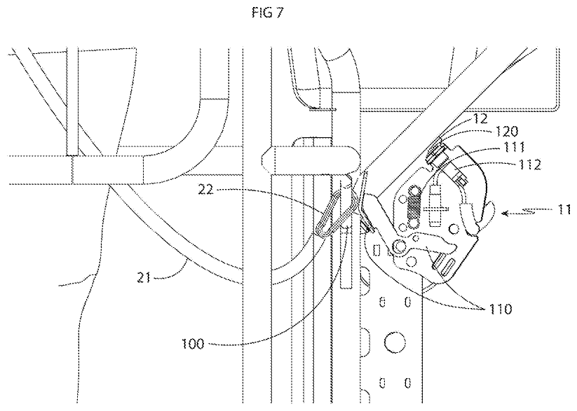

The platform 3 also comprises at least one anchoring location 10 liable to be occupied by a device 22 for anchoring an item of safety equipment 21, such as a harness. Indeed, generally and as in the example shown, the operator 20 wears an item of safety equipment 21 in the form of a harness. This harness is equipped with a tether, the free end of which is provided with a device 22 for anchoring the tether to the anchoring location 10. This anchoring device 22 may be a carabiner as in the example shown in FIG. 7.

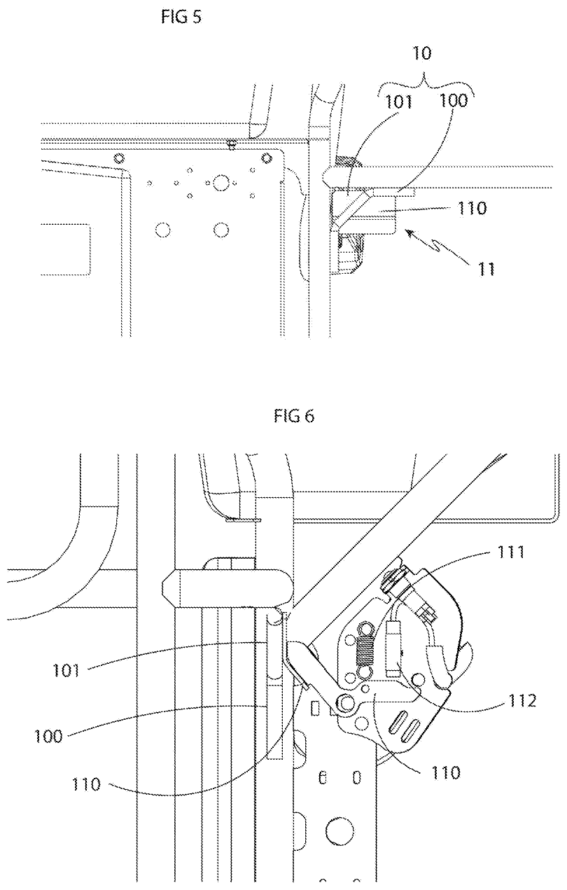

The anchoring location 10 can assume a large number of forms. This anchoring location 10 is particularly visible in FIG. 5 and has in this case the form of a frame 100 delimiting an opening 101. The frame 100 is provided at the guardrail 19.

The anchoring device 22 may thus form a loop closed around an edge of the frame. This frame 100 is delimited with the aid of tubes used to produce the guardrail, which is itself formed by the assembly of uprights and crossmembers where each upright or crossmember is a tube.

The frame 100 is in this case formed with the aid of a tube connecting a crossmember and an upright of the guardrail 19 so as to form a frame of triangular shape. This frame has two opposite faces. Of course, other designs of the anchoring location 10 can be envisioned without departing from the scope of the invention.

The platform 3 also comprises a system 11 for detecting the occupied or unoccupied state of the anchoring location 10 by the anchoring device 22, and the control unit 7 is configured at least to acquire data from the detection system 11 as a function of the occupied or unoccupied state of the anchoring location 10.

The system 11 for detecting the occupied or unoccupied state of the anchoring location 10 comprises, disposed along a face of the frame 100 formed by the anchoring location 10, a mechanical member 110 mounted so as to be movable between a position close to the anchoring location 10, corresponding to the unoccupied position of the anchoring location 10, and a position spaced apart from the anchoring location 10, corresponding to the occupied position of the anchoring location 10, an element 111 for returning said mechanical member 110 into the position close to the anchoring location 10 and a sensor 112 for determining the position of the mechanical member 110. The control unit 7 is configured to acquire the data supplied by the sensor 112 for determining the position of the mechanical member 110.

In particular, in the example shown in FIGS. 6 and 7, the mechanical member 110 is a pivoting flap extending along the frame parallel to a face of the frame. This flap pivots about an axis parallel to a face of the frame. The return element 111 for the mechanical member 110 is an elastically deformable element, such as a return spring, which tends to return the mechanical member 110 into the position close to the frame 100. The sensor 112 for determining the position of the mechanical member 110 is an inductive sensor for detecting the pivoted or non-pivoted position of the mechanical member 110.

Thus, when an anchoring device 22, such as a carabiner, is introduced into the frame 100, it results in a pivoting movement of the mechanical member 110 in the direction for spacing said mechanical member 110 apart from the frame. This movement is detected by the sensor 112 for determining the position of the mechanical member 110 and a signal is sent by said sensor 112 for determining the position of said mechanical member 110 to the control unit 7.

The aerial lift 1 also comprises a device 12 for emitting a luminous or audible warning signal. In the examples shown, the device 12 for emitting a luminous or audible warning signal is a device 12 for emitting a luminous warning signal which comprises at least one lighting member 120, such as a light-emitting diode, disposed around at least one of the anchoring locations 10 within a radius of less than 15 cm.

This device 12 for emitting a luminous or audible warning signal also comprises a luminous indicator 121 which is disposed on the control console 8 and follows the same type of display as the lighting member 120 positioned as close as possible to the anchoring location 10. Thus, the operator has these luminous warning signals under their eyes.

The positioning of the luminous warning as close to the anchoring location 10 as possible makes it possible to remind the operator 20 of the origin of the warning, namely the absence of an anchoring device 22 at the anchoring location 10.

The aerial lift 1 also comprises a system 13 for determining the position of the lift structure 6 for the platform 3. If the lift structure 6 comprises a lifting arm 61 mounted so as to be pivotable with respect to the chassis 2 between a low position and a high position, the system 13 for determining the position of the lift structure 6 for the platform 3 is a system for determining the position of the lifting arm 61 of said lift structure 6.

Thus, the system 13 for determining the position of the lifting arm 61 for the platform 3 may comprise at least a position sensor 131 for the lifting arm 61 and/or a position sensor 132 for the actuator 14 for driving the movement of the lifting arm 61 between a high position and a low position.

In the case of a position sensor 131 for the lifting arm 61, this position sensor 131 may be in the form of an angular sensor. In the case of a position sensor 132 for the actuator, this sensor may be a pressure sensor housed inside the actuator 14. If the lift structure is a scissor-type structure, the system 13 for determining the position of the lift structure 6 for the platform 3 may be a sensor for detecting the low position of said scissor-type structure.

Lastly, generally for safety reasons, the platform 3 comprises at least one member 17 for activating/deactivating at least a portion of the control or controls 9 for the device 5 for driving the movement of the platform 3 which equip the control console 8. This activating/deactivating member 17 is mounted so as to be movable between an inactive position, in which at least a portion of the control or controls 9 for the device 5 for driving the movement of the platform 3 is inactive, and an active position, in which at least a portion of the control or controls 9 for the device 5 for driving the movement of the platform 3 is active. Active is understood to mean that the signals from the control or controls 9 can be taken into account by the control unit 7.

This activating/deactivating member 17 may be a pedal or a lever equipped with at least one member for returning into the active position and be configured to pass from the inactive position to the active position under the action of a push exerted on said activating/deactivating member 17 counter to said at least one return member.

In the example shown in the figures, it is a pedal referred to as dead man's pedal returned into the inactive position by a spring which is provided. A position sensor for said activating/deactivating member 17 is provided. The control unit 7 is configured to acquire data from the position sensor for the activating/deactivating member 17 as a function of the position of said activating/deactivating member 17. In the state when the activating/deactivating member 17 is positioned in the active position, the operator can use the control or controls 9 for the device 5 for driving the platform and the signals from the control or controls 9 are received and processed by the control unit 7.

The control unit 7 is configured to, in the unoccupied state of the anchoring location 10, control the emission of a warning signal, of which the intensity and/or the frequency and/or the tonality, i.e. the color for a luminous warning signal or the melody for an audible warning signal, varies at least as a function of the position of the lift structure 6.

The control unit 7 is also configured to, in the unoccupied state of the anchoring location 10, control the emission of a warning signal, of which the intensity and/or the frequency and/or the tonality, i.e. the color for a luminous warning signal or the melody for an audible warning signal, varies at least as a function of the position of said activating/deactivating member 17.

The method for controlling the aerial lift 1 therefore comprises, in the unoccupied state of the anchoring location 10, a step of emitting a warning signal, of which the intensity and/or the frequency and/or the tonality, i.e. the color for a luminous warning signal or the melody for an audible warning signal, varies at least as a function of the position of the lift structure 6.

In practice, the lighting of the lighting member, such as the light-emitting diode, constituting the luminous warning signal is effected as follows, it being understood that the lighting of the luminous indicator when it is present is effected in a similar manner to that of the lighting member.

When the anchoring location 10 is occupied by the anchoring device 22, the lighting member is turned off and no luminous warning signal is emitted.

When the anchoring location 10 is not occupied by the anchoring device 22 and an operator 20 is on the platform 3 and has started the aerial lift 1, the lighting member lights up and is, for example, a solid green color.

As soon as the operator acts on the member 17 for activating/deactivating at least a portion of the controls 9 for the device 5 for driving the movement of the platform 3, this action is detected via the position sensor for the activating/deactivating member 17 and the control unit 7 controls a flashing of the lighting member at a first frequency. This flashing may be accompanied by a change in the color of the lighting member which passes from green to orange.

As soon as the operator 20 controls a lifting of the lifting arm 61, this lifting is detected by the system 13 for determining the position of the lift structure 6. The control unit controls a flashing of the lighting member at a higher frequency and possibly a change in the color of the lighting member which passes from orange to red.

Thus, the operator can very easily be warned as a function of the fall risk involved and the luminous warning signal can vary as a function of said risk.

1. An aerial lift comprising:
a chassis;
a platform having a zone for receiving an operator;
a first device for moving the platform respect relative to the chassis, the first device including a lift structure to raise and lower the platform; and
a control unit,
wherein the platform includes a control console equipped with one or more controls for the first device, an anchoring location configured to be occupied by a second device for anchoring an item of safety equipment, a first system for detecting a state of occupation of the anchoring location, the state of occupation being one of an occupied state or an unoccupied state, and a third device for emitting a warning signal, the control unit being configured to acquire data from the first system as a function of the state of occupation of the anchoring location,
wherein the aerial lift includes a second system for determining a position of the lift structure for the platform, and the control unit is configured to control the third device to emit the warning signal as a function of the state of occupation of the anchoring location and the position of the lift structure, the control unit being configured to, in the unoccupied state of the anchoring location, control emission of the warning signal, of which one or more of an intensity, a frequency, a tonality, or a color for a luminous warning signal, or a melody for an audible warning signal, varies as a function of the position of the lift structure.

2. The aerial lift of claim 1, wherein
the lift structure includes a lifting arm that is pivotable relative to the chassis between a low position and a high position, and
the second system determines a position of the lifting arm of the lift structure.

3. The aerial lift of claim 2, wherein
the first device includes an actuator for driving movement of the lifting arm, and
the second system includes one or more of a position sensor for the lifting arm or a position sensor for the actuator.

4. The aerial lift of claim 2, wherein
the lifting arm for the platform is disposed between the chassis and the platform and is coupled to the platform by a pendulum arm, and
the controls for the first device included in the control console comprise at least a movement control for the pendulum arm and a movement control for the lifting arm.

5. The aerial lift of claim 1, wherein
the chassis is equipped with a third system for moving the chassis along the ground, and
the control console is equipped with at least one member for controlling the third system.

6. The aerial lift of claim 1, wherein
the platform includes a dead man's actuator for activating and deactivating at least a portion of the controls for the first device, the dead man's actuator being movable between an inactive position, in which at least the portion of the controls for the first device is inactive, and an active position, in which at least the portion of the controls for the first device is activated, and
the control unit is configured to, in the unoccupied state of the anchoring location, control emission of the warning signal, of which one or more of the intensity, the frequency, the tonality, or the color for the luminous warning signal, or the melody for the audible warning signal, varies at least as a function of a position of the dead man's actuator.

7. The aerial lift of claim 1, wherein
the platform includes a floor and a guardrail surrounding at least a portion of the floor, and
the anchoring location is a frame delimiting an opening, the frame being provided at the guardrail.

8. The aerial lift of claim 7, wherein
the first system includes, disposed along a face of the frame formed by the anchoring location, a mechanical member movable between
a first position adjacent to the anchoring location, the first position corresponding to the unoccupied state of the anchoring location, and
a second position spaced apart from the anchoring location, the second position corresponding to the occupied state of the anchoring location,
the mechanical member including a return element for returning the mechanical member to the first position and a sensor for determining the position of the mechanical member, and
the control unit is configured to acquire data supplied by the sensor for determining the position of the mechanical member.

9. The aerial lift of claim 1, wherein
the third device includes a lighting member disposed around the anchoring location within a radius of less than 15 cm.

10. The aerial lift of claim 1, wherein the third device includes a luminous indicator disposed on the control console.

11. An assembly comprising:
an aerial lift; and
a harness equipped with an anchoring device,
wherein the aerial lift includes
a chassis,
a platform having a zone for receiving an operator,
a device a movement device for moving the platform relative to the chassis, the movement device comprising a lift structure for the platform that is movable to raise and lower the platform, and
a control unit,
wherein the platform includes
a control console equipped with one or more controls for the movement device,
an anchoring location for anchoring the harness via the anchoring device,
a detection system for detecting a state of occupation of the anchoring location by the anchoring device, the state of occupation being one of an occupied state or an unoccupied state, the control unit being configured to acquire data from the detection system as a function of the state of occupation of the anchoring location, and
a warning device for emitting one or more of a luminous warning signal or an audible warning signal,
wherein the aerial lift includes a positioning system for determining a position of the lift structure for the platform, and
wherein the control unit is configured to control the warning device as a function of the state of occupation of the anchoring location and the position of the lift structure, the control unit being configured to, in the unoccupied state of the anchoring location, control emission of the warning signal, of which one or more of an intensity, a frequency, a tonality, or a color for a luminous warning signal, or a melody for the audible warning signal, varies as a function of the position of the lift structure.

12. A method for controlling an aerial lift, wherein the aerial lift includes
a chassis,
a platform having a zone for receiving an operator,
a movement device for moving the platform with respect to the chassis, the movement device comprising a lift structure for the platform that is movable in a direction of a raising and a lowering of the platform, and
a control unit,
the platform comprising a control console equipped with one or more controls for the movement device, an anchoring location for anchoring an anchoring device of an item of safety equipment, a detection system for detecting an occupied state or an unoccupied state of the anchoring location by the anchoring device and a warning device for emitting one or both of a luminous warning signal or an audible warning signal, the control unit being configured to acquire data from the detection system as a function of the occupied state and the unoccupied state of the anchoring location,
wherein the aerial lift includes a position system for determining a position of the lift structure for the platform, the method comprising:
emitting a warning signal when the anchoring location is in the unoccupied state, of which one or more of an intensity, a frequency, a tonality, or a color for the luminous warning signal, or a melody for an audible warning signal, varies at least as a function of the position of the lift structure.

13. The aerial lift of claim 11, wherein the anchoring device is provided in the from of a carabiner.

14. The aerial lift of claim 11, wherein
the lift structure includes a lifting arm pivotable relative to the chassis between a low position and a high position, and
the positioning system determines the position of the lift structure via the lifting arm.

15. The aerial lift of claim 14, wherein
the movement device includes an actuator to move the lifting arm, and
the positioning system includes one or more of a first position sensor for the lifting arm and a second position sensor for the actuator.

16. The aerial lift of claim 14, wherein
the lifting arm is disposed between the chassis and the platform,
the lifting arm is coupled to the platform by a pendulum arm, and
the controls for the movement device include one or more of a first movement control for the pendulum arm and a second movement control for the lifting arm.

17. The aerial lift of claim 11, wherein
the chassis is equipped with a ground movement system for moving the chassis along the ground, and
the control console is equipped with at least one member for controlling the ground movement system.

18. The aerial lift of claim 11, wherein
the platform includes an activation member for activating and deactivating at least a portion of the controls for the movement device, the activation member being movable between
an inactive position, in which at least the portion of the controls for the movement device is inactive, and
an active position, in which at least the portion of the controls for the movement device is activated, and
the control unit is configured to, when the anchoring location is in the unoccupied state, control emission of the luminous warning signal and the audible warning signal, the luminous warning signal and the audible warning signal having one or more of the intensity, the frequency, the tonality, the color, or the melody vary based on an activation position of the activation member.

19. The aerial lift of claim 11, wherein
the platform includes a floor and a guardrail surrounding at least a portion of the floor, and
the anchoring location includes a frame delimiting an opening, the frame being provided at the guardrail.

20. The aerial lift of claim 19, wherein
the detection system is disposed along a face of the frame and includes a mechanical member movable between
a first position adjacent to the anchoring location, the first position corresponding to the unoccupied state of the anchoring location, and
a second position spaced apart from the anchoring location, the second position corresponding to the occupied state of the anchoring location,
the detection system includes an element to return the mechanical member to the first position and a location sensor to locate the mechanical member, and
the control unit is configured to acquire data supplied by the location sensor.
